(19) United States
(12) Patent Application Publication
(10) Pub. No.: US 2026/0359890 A1
(43) Pub. Date: Nov. 12, 2026

(54) METHOD AND SYSTEM FOR AUTOMATED MANUFACTURED HOUSING CHATTEL LOAN UNDERWRITNG WITH ITERATIVE COUNTEROFFER GENERATION

(71) Applicant: Tammac Holdings Corporation, Wayne, PA (US)

(72) Inventor: Troy Devin Cavallaro, West Chester, PA (US)

(73) Assignee: Tammac Holdings Corporation, Wayne, PA (US)

(21) Appl. No.: 19/671,772

(22) Filed: May 8, 2026

Related U.S. Application Data
(60) Provisional application No. 63/802,102, filed on May 8, 2025.

(51) Int. Cl. G06Q 40/03; G06Q 50/16

(52) U.S. Cl. CPC G06Q 40/033; G06Q 50/165

(57) ABSTRACT

A computer-implemented system and method for automated manufactured housing chattel loan underwriting with iterative counteroffer generation. The system receives loan application data, retrieves a credit report from a credit bureau computing system, and assigns the application to one of a plurality of program branches via a waterfall cascade. Manufactured housing-specific financial ratios are computed, including a housing ratio incorporating a lot rent component determined by land type classification, a debt-to-income ratio with tradeline-specific imputation rules, and a loan-to-value ratio based on dealer invoice pricing. Two mutually exclusive iterative counteroffer processes adjust the down payment by either a percentage increment or a fixed dollar increment until all ratio thresholds are satisfied or an exit condition is met. ITIN borrowers are processed through a specialized pathway with default credit score assignment and program-specific underwriting rules. A configurable administrative interface permits modification of underwriting parameters without code changes.

### CROSS-REFERENCE TO RELATED APPLICATIONS

This application claims priority to U.S. Provisional Application No. 63/802,102, filed May 8, 2025, the entire disclosure of which is incorporated herein by reference.

### TECHNICAL FIELD

The present disclosure relates generally to automated loan underwriting, and more particularly to a computer-implemented method and system for automated underwriting of manufactured housing chattel loans with iterative counteroffer generation. The disclosed system employs manufactured housing (MH) specific financial ratios, automated borrower classification and risk stratification, and a configurable rules engine to evaluate loan applications, generate approval or denial determinations, and produce one or more counteroffers when an initial loan application fails to satisfy one or more underwriting criteria.

### BACKGROUND OF THE INVENTION

Conventional automated underwriting systems (AUS), including those used in connection with secondary mortgage market participants, are designed primarily for site-built residential real estate mortgage transactions. These systems evaluate a borrower's creditworthiness and the collateral value of the property using models, guidelines, and data structures tailored to conventional mortgage lending. However, manufactured housing chattel loans, which are personal property loans secured by a manufactured home without the underlying land, present a fundamentally different risk profile and may require a distinct underwriting methodology.

One deficiency associated with conventional AUS platforms is their reliance on loan-to-value (LTV) ratios computed from an appraised value of real property. In at least some manufactured housing chattel transactions, a real property appraisal may not be performed, and the collateral value may instead be derived from a dealer invoice price or other non-appraisal-based valuation. Conventional AUS platforms generally lack the data fields and calculation logic necessary to compute a loan-to-value ratio based on such alternative valuation inputs, which may limit their applicability in evaluating such loans.

Another deficiency may include the inability of conventional AUS platforms to account for recurring lot rental obligations. Manufactured housing residents who do not own the underlying land often pay monthly lot rent to a community operator. This recurring obligation may materially affect the borrower's debt-to-income (DTI) ratio and overall repayment capacity, yet conventional AUS platforms typically do not provide mechanisms for incorporating lot rent into DTI calculations or housing expense ratios.

A further deficiency may relate to the lack of support for borrowers who possess an Individual Taxpayer Identification Number (ITIN) rather than a Social Security Number (SSN). ITIN borrowers may represent a significant segment of the manufactured housing market. Conventional AUS platforms often rely on an SSN for credit bureau retrieval and identity verification, and may not be configured to accommodate specialized scoring and underwriting logic for ITIN borrowers, such as default credit score assignment when no FICO score is available.

Another potential limitation is the binary, pass/fail decisioning model employed by many conventional AUS platforms. When a loan application does not satisfy one or more underwriting criteria, such systems may issue a denial without providing the borrower or lender with actionable alternatives. This approach may fail to account for scenarios in which adjustments to loan terms, for example, an increased down payment, a reduced loan amount, or an extended loan term, could bring the application into compliance with underwriting guidelines. The absence of an automated counteroffer mechanism may result in lost lending opportunities and increased manual intervention by underwriting personnel.

Another limitation may include the failure of conventional AUS platforms to address manufactured housing-specific considerations. Such considerations may include, but are not limited to, compliance with the U.S. Department of Housing and Urban Development (HUD) Code manufacturing standards, distinctions between new and pre-owned units, setup allowance financing, tiered origination fee structures, property tax treatments applicable to manufactured housing, and community or dealer relationship management. These considerations may be integral to prudent chattel loan underwriting but are not fully addressed by the data models and decision logic of many conventional AUS platforms.

Accordingly, there is a need for systems and methods configured to address one or more of the foregoing deficiencies. Such systems and methods may provide iterative counteroffer generation, support for ITIN borrowers, incorporation of manufactured housing-specific financial ratios and collateral valuation methodologies and be governed by a configurable rules engine adaptable to evolving business requirements and regulatory considerations.

### SUMMARY OF THE INVENTION

In a first aspect, the present disclosure provides a computer-implemented method for automated underwriting of manufactured housing chattel loans. The method comprises receiving a loan application data set comprising borrower information and manufactured home collateral data; executing a two-stage rules evaluation comprising a first stage of pre-qualification rules and a second stage of full underwriting rules arranged in a waterfall cascade; computing one or more MH-specific financial ratios including a loan-to-value ratio based on dealer invoice pricing, a housing expense ratio incorporating lot rent obligations, and a debt-to-income ratio; classifying the borrower into one of a plurality of risk tiers based on the computed ratios and borrower credit data; and generating, responsive to the two-stage rules evaluation, one of an approval determination, a denial determination, or one or more counteroffer proposals specifying modified loan terms under which the loan application would satisfy the underwriting criteria. The method may be implemented by one or more processors executing instructions stored in memory.

In a second aspect, the present disclosure provides two mutually exclusive counteroffer generation processes. A first process is triggered when a borrower's stated down payment is below a program minimum while applicable financial ratios satisfy corresponding thresholds. The first process iteratively increases the down payment by a percentage increment of a home price and recalculates the financial ratios at each iteration until the financial ratios simultaneously satisfy the applicable thresholds or an exit condition is met. A second process is triggered when the stated down payment meets the program minimum and one or more financial ratios do not satisfy corresponding thresholds within defined boundary tolerances. The second process iteratively increases the down payment by a fixed dollar increment to reduce a loan amount and recalculates the financial ratios at each iteration until the financial ratios simultaneously satisfy the applicable thresholds or a maximum iteration count is reached. The first process and the second process are mutually exclusive such that only one of the processes is executed for a given loan application. The processes may be implemented by one or more processors executing instructions stored in memory.

In a third aspect, the present disclosure provides a method for processing loan applications from ITIN borrowers. The method comprises detecting that a borrower identification number begins with a specific digit indicating an ITIN; verifying that the originating lending partner has opted into a program branch that permits ITIN borrowers; assigning a fixed default credit score to the application when the credit report does not contain a credit score; restricting the ITIN borrower to processing under the lowest-tier program branch regardless of any actual credit score; and applying ITIN-specific underwriting rules comprising at least a fixed interest rate, an elevated minimum down payment requirement, and an extended employment history requirement. The method may be implemented by one or more processors executing instructions stored in memory.

In a fourth aspect, the present disclosure provides a configurable rules engine organized as a waterfall decision tree with embedded scoring logic. An administrative user interface enables authorized personnel to modify operational parameters including pricing matrices, down payment requirements per loan program, origination fee percentages, mortgage loan originator auto-assignment rules, property tax millage rates, decision email notification templates, reason code management, and partner/community management and program assignment, all without requiring modification of the underlying application source code. Changes made through the administrative user interface are published to the production environment within minutes. The rules engine may be implemented by one or more processors executing instructions stored in memory.

### BRIEF DESCRIPTION OF THE DRAWINGS

FIG. 1 illustrates a physical application intake flow and a point-of-sale (POS) application intake flow for a manufactured housing chattel loan underwriting system;

FIG. 2 is a flowchart illustrating an automated underwriting method for manufactured housing chattel loans;

FIG. 3 is a block diagram illustrating a system architecture for the manufactured housing chattel loan underwriting system;

FIG. 4 is a flowchart illustrating a counteroffer decision routing process;

FIG. 5 is a flowchart illustrating a first counteroffer process;

FIG. 6 is a flowchart illustrating a second counteroffer process;

FIG. 7 is a comparison diagram illustrating differences between the first and second counteroffer processes;

FIG. 8 is a flowchart illustrating an end-to-end application processing example through counteroffer generation;

FIG. 9 is a flowchart illustrating an ITIN borrower processing flow;

FIG. 10 is a comparison diagram illustrating differences between standard and ITIN borrower counteroffer processing;

FIG. 11 is a block diagram illustrating a rules engine architecture with administrative configuration layer;

FIG. 12 is a flowchart illustrating a waterfall cascade decision process across program branches;

FIG. 13 is a flowchart illustrating credit report XML processing and tradeline analysis;

FIG. 14 is a flowchart illustrating pre-bureau and post-bureau rule evaluation stages;

FIG. 15 is a decision tree illustrating lot rent determination based on land type classification;

FIG. 16 is a comparison diagram illustrating manufactured housing versus conventional housing expense components;

FIG. 17 is a flowchart illustrating manufactured housing property classification and loan-to-value calculation; and

FIG. 18 is a hub-and-spoke diagram illustrating manufactured housing specific underwriting variables.

### DETAILED DESCRIPTION OF THE PREFERRED EMBODIMENTS

### System Architecture Overview

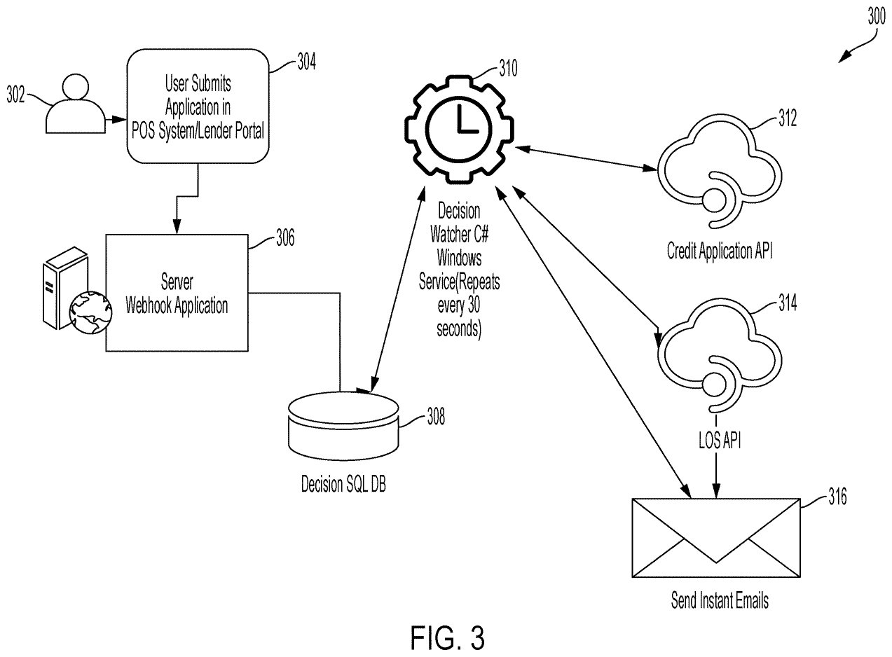

FIG. 3 illustrates a system architecture 300 for the automated decisioning system (hereinafter also referred to as the “Instant Decision” system or “the system”) for automated underwriting and pricing of manufactured housing chattel loan applications in accordance with one or more embodiments of the present disclosure. The system architecture 300 is configured to receive loan application data from one or more submission sources 302, process the application data through a series of automated evaluation stages, and generate one or more decisioning outputs (e.g., approval, counteroffer, pend out, or decline). The system architecture 300 comprises four main processing components that cooperate to ingest, store, evaluate, and communicate loan application information in a substantially real-time, automated fashion.

In various embodiments, the four main components of the system architecture 300 include: (1) an intake interface module 304, which receives application data from external submission sources 302; (2) a webhook application server (e.g., implemented using Internet Information Services (IIS)) 306, which provides event-driven communication and data routing between internal modules; (3) a relational database 308 (e.g., SQL Server), which persistently stores application records, configuration parameters, and processing results; and (4) a Watcher Service 310, which orchestrates the core underwriting logic, interfaces with external systems via a credit bureau API 312 and a loan origination system (LOS) API 314, and triggers email notification outputs 316 upon completion of decisioning.

The user and/or application submission interface 302 represents the originating source of loan application data entering the system architecture 300. In various embodiments, the submission interface 302 may correspond to a borrower, a dealer, a loan officer, or an automated upstream system that transmits application information to the intake interface module 304. The submission interface 302 provides applicant demographic data, requested loan parameters, property information, and any supplementary documentation for underwriting evaluation.

The intake interface module 304 is configured to receive incoming electronic loan application data from one or more alternative intake channels. The electronic loan application data received by the system comprises, without limitation, a borrower identification number (e.g., SSN or ITIN), income data, employment data, property information including a home price and a land type classification, and/or a stated down payment amount. In a first channel, a point-of-sale (POS) system provides a borrower-facing digital interface through which applicants may directly submit loan applications electronically. In a second, alternative channel, a Lender Portal provides a lender-facing interface through which loan officers or dealer representatives may manually enter or upload application data on behalf of a borrower. Both the POS system and the Lender Portal operate as alternative intake pathways within the intake interface module 304, and each channel formats and normalizes the received data for downstream processing by the webhook application server 306. The intake interface module 304 thus abstracts the submission source, ensuring that regardless of which channel is utilized, the application data is presented in a consistent schema to subsequent processing stages.

The webhook application server 306 functions as an event-driven middleware layer within the system architecture 300. Upon receiving formatted application data from the intake interface module 304, the webhook application server 306 validates the incoming payload, assigns internal tracking identifiers, and persists the application record to the relational database 308. The webhook application server 306 further generates event notifications that signal the availability of new application data to downstream services, including the Watcher Service 310. In certain embodiments, the webhook application server 306 may also handle callback communications, status update requests, and inter-module messaging to coordinate processing across the system architecture 300.

The webhook application server 306 authenticates incoming API requests using Bearer Token Authentication. Each client is issued a unique, cryptographically secure token. The token must be included in the HTTP Authorization header of every API request transmitted to the webhook application server 306. The webhook application server 306 validates the token before processing any received data.

The relational database 308 (e.g., SQL Server) serves as the central data repository for the system architecture 300. The relational database 308 stores, for example, application records, applicant profile data, credit bureau response data, program parameter configurations, pricing grid definitions, rule evaluation results, and/or final decisioning outcomes. Each application processed by the system architecture 300 maintains a corresponding record within the relational database 308, enabling audit trail preservation, historical analysis, and real-time status tracking. The relational database 308 is accessible to the webhook application server 306, the Watcher Service 310, and other authorized components for both read and write operations.

The relational database 308 is organized around a primary transaction table that stores the master record for each loan application processed by the system. The Watcher Service 310 identifies applications requiring processing by querying the primary transaction table for records where a processing status flag indicates the record is unprocessed (e.g., IsProcessed=false). The relational database 308 further includes a plurality of configuration and lookup tables, including a client settings table storing client-specific credentials and configuration parameters, a loan program configuration table defining program branch thresholds and parameters, a loan program partners table storing partner-specific program assignments, a loan officer mapping table maintaining partner-to-MLO assignment relationships, and a fee lookup table storing fee schedule parameters. All underwriting business logic resides in the application code layer; the relational database 308 does not contain stored procedures that perform business logic.

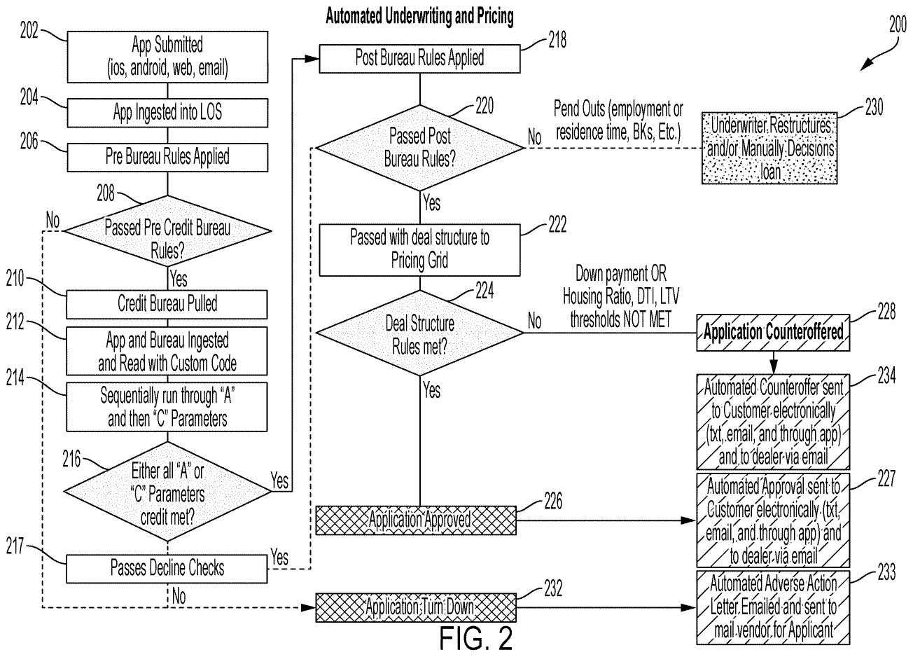

The Watcher Service 310 constitutes the primary underwriting and decisioning engine within the system architecture 300. The Watcher Service 310 monitors the relational database 308 for newly ingested application records and, upon detecting a new record, initiates the automated underwriting pipeline. As part of this pipeline, the Watcher Service 310 communicates with a credit bureau computing system via the credit bureau API 312 to retrieve credit report data and credit scores for the applicant. The Watcher Service 310 further interfaces with an external loan origination system via the LOS API 314 to transmit decisioning results, application status updates, and structured loan data. The Watcher Service 310 orchestrates, for example, the sequential evaluation of pre-bureau rules, credit data ingestion, program parameter evaluation, post-bureau rules, deal structure analysis, and/or pricing grid application, as further described herein with reference to FIG. 2.

The Watcher Service 310 employs a state-machine approach to manage application processing. The Watcher Service 310 fetches only unprocessed records from the primary transaction table in the relational database 308 and marks each retrieved record as in-progress to prevent double-handling. When a processing error occurs, the error is logged to the relational database 308 and exposed through the Administrative User Interface for review. Critical errors trigger an automated Decision Trace Email dispatched to designated support personnel.

The Watcher Service 310 integrates with an external credit data provider via a secure REST API. If a timeout or error occurs during the credit data retrieval, the exception is caught and logged against the specific loan application record in the relational database 308. Users may manually trigger a re-process action through the Administrative User Interface once the error condition has been resolved. The Watcher Service 310 integrates with an external loan origination system via a standard RESTful API suite. The LOS integration supports creation and retrieval of loan files, data synchronization including granular field updates and bulk loan object updates, and workflow management operations including moving loans between folders and updating milestones within the LOS.

Upon completion of the decisioning pipeline, the system architecture 300 generates an email notification output 316 to communicate the result to relevant parties, such as the originating loan officer, the borrower, or a designated recipient. The email notification output 316 may include, for example, a summary of the decisioning outcome (e.g., approval, counteroffer, pend out, or decline), along with any applicable conditions, stipulations, or counteroffer terms. Collectively, the intake interface module 304, the webhook application server 306, the relational database 308, and the Watcher Service 310 cooperate in concert to provide a fully automated, end-to-end loan application underwriting and pricing system that minimizes manual intervention, reduces processing latency, and ensures consistent application of configurable underwriting rules and pricing parameters.

### Application Intake and Processing Flows

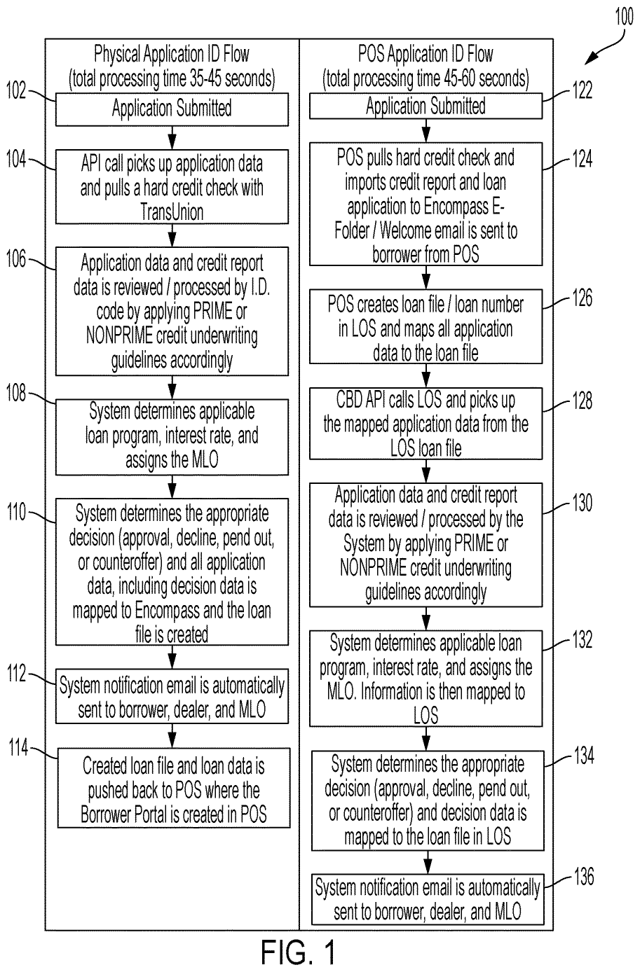

FIG. 1 illustrates exemplary application flows in accordance with one or more embodiments of the present disclosure.

A physical application flow 100 defines the processing sequence for loan applications received through the Lender Portal or a dealer channel within the intake interface module 304, with a target total processing time from application submission to decision delivery of approximately 35 to 45 seconds.

At step 102, a loan application is submitted through the Lender Portal or a dealer channel. The application data includes borrower identification information, requested loan parameters, property details, and manufactured home collateral information.

At step 104, an API call associated with the decisioning system picks up the application data and initiates a hard credit check with a credit bureau computing system via the credit bureau API 312 (FIG. 3). The credit bureau computing system returns a credit report (e.g., an XML-formatted credit report) containing the borrower's credit score and tradeline data.

At step 106, the application data and the retrieved credit report data are reviewed and processed by the automated decisioning system code. The automated decisioning system code applies the appropriate underwriting guidelines for the assigned program branch, including the pre-bureau and post-bureau rules, the credit report processing, and the manufactured housing-specific ratio calculations, all as described in detail later.

At step 108, the automated decisioning system code determines the applicable loan program based on the waterfall cascade described later, determines the interest rate using the scoring matrix, and automatically assigns a Mortgage Loan Officer (MLO) based on the configurable assignment rules described later.

At step 110, the automated decisioning system code determines the appropriate decision (conditional approval, counteroffer, decline, or pend out) and all application data, including decision data, is mapped to the loan origination system (LOS) via the LOS API 314 (FIG. 3). A loan file is created in the LOS containing the complete application record and decisioning outcome.

At step 112, a notification email is automatically sent to the borrower, the dealer, and the assigned MLO, subject to the consent-verification logic described later.

At step 114, the loan file created at step 112, now containing the complete application data, program assignment, pricing, and decisioning outcome from steps 134 and 136, is pushed back to the POS platform where a Borrower Portal is created enabling the borrower to view the decision and any applicable conditions or counteroffer terms.

A point-of-sale (POS) application flow 120 defines the processing sequence for loan applications received through a borrower-facing POS platform within the intake interface module 304, with a target total processing time of approximately 45 to 60 seconds due to additional system integration steps.

At step 122, a loan application is submitted through a POS platform (e.g., a web portal or mobile application). The POS platform provides a borrower-facing digital interface through which applicants directly enter loan application data.

At step 124, the POS platform pulls a hard credit check with a credit bureau computing system and imports the credit report data and the loan application data to the loan origination system (LOS), and a welcome email is sent to the borrower from the POS platform, acknowledging receipt of the application.

At step 126, the POS platform creates a loan file and assigns a loan number in the LOS and maps all application data to the loan file. This loan file, created by the POS platform at this step, serves as the persistent record that is subsequently updated with decisioning data in later steps of this flow.

At step 128, an API associated with the decisioning system calls the LOS and picks up the mapped application data from the loan file created at step 128 for processing by the automated decisioning system code.

At step 130, the application data and credit report data are reviewed and processed by the automated decisioning system code, applying the same underwriting guidelines, credit report processing, and manufactured housing-specific ratio calculations as described in connection with the physical application flow 100 of FIG. 1.

At step 132, the automated decisioning system code determines the applicable loan program, interest rate, and assigns the MLO. This information is mapped back to the loan file in the LOS.

At step 134, the automated decisioning system code determines the appropriate decision (conditional approval, counteroffer, decline, or pend out) and maps the decision data to the loan file created by the POS platform at step 128.

At step 136, notification email is automatically sent to the borrower, the dealer, and the assigned MLO, subject to the consent-verification logic described later.

### Automated Underwriting and Pricing Method Overview

FIG. 2 illustrates an automated underwriting and pricing method 200 for evaluating loan applications in accordance with one or more embodiments of the present disclosure. The method 200 defines a sequential pipeline of evaluation steps, each of which applies a distinct set of rules, data retrievals, or analytical computations to the application data. The method 200 begins with application submission and concludes with one of four possible decisioning outputs: approval, counteroffer, pend out, or decline. Each step of the method 200 is described below in summary form, with cross-references to the detailed sections that follow.

At step 202, the system receives a loan application submission from a borrower, dealer, or loan officer through one of the intake channels described above, as further elaborated above. The application data includes borrower identification information, requested loan parameters, property details, and any supplementary inputs provided at the time of submission.

At step 204, the system ingests the application data into the loan origination system (LOS) and persists the application record within the relational database 308, as described above. The ingestion step includes payload validation, field normalization, record creation, and assignment of internal tracking identifiers that enable downstream modules to reference the application throughout the pipeline.

At step 206, the system applies a set of pre-bureau rules to the application data, discussed in greater detail later. The pre-bureau rules evaluate threshold criteria that can be assessed without reference to the applicant's credit report data. At step 208, the system determines whether the application has passed the pre-bureau rules. If the application fails one or more pre-bureau rules, the method 200 routes the application toward a decline output at step 232. If the application passes all pre-bureau rules, the method 200 proceeds to step 210.

At step 210, the system initiates a credit bureau pull by transmitting a request to a credit bureau computing system via the credit bureau API 312, elaborated upon later. The credit bureau computing system returns credit report data, including credit scores, tradeline histories, and other credit profile attributes for the applicant. At step 212, the system ingests the returned credit bureau data alongside the original application data using custom code logic that maps, transforms, and consolidates the combined data into a unified evaluation record, as described in further detail later.

At step 214, the system sequentially evaluates the application against the first program branch (“A”) parameters and then the second program branch (“C”) parameters, as discussed in greater detail later. At step 216, the system determines whether either all “A” parameters or all “C” parameters for credit are met. If one or more program parameter sets are satisfied, the method 200 proceeds directly to step 218 (Post-Bureau Rules Applied). If neither set of program parameters is satisfied, the method 200 evaluates at a secondary step 217 whether the application passes decline checks. If the application does not pass the decline checks at step 217, the method 200 routes the application to a decline output at step 232 and the application is turned down. If the application passes the decline checks at step 217, the method 200 proceeds directly to step 220 (Passed Post-Bureau Rules?), bypassing the post-bureau rules application step 218. This routing allows the system to evaluate whether the application's existing post-bureau data (down payment, ratios) satisfies the post-bureau thresholds without reprocessing.

At step 218, the system applies a set of post-bureau rules to the application data, as described in further detail later. The post-bureau rules evaluate criteria that require credit report data, including tradeline analysis, employment and income verification, and financial ratio calculations. At step 220, the system determines whether the application has passed the post-bureau rules. If the application fails one or more post-bureau rules, the method 200 may route the application toward a decline output at step 232, a counteroffer output at step 228, or a pend out output at step 230, depending on the nature and severity of the rule failure. If the application passes all post-bureau rules, the method 200 proceeds to step 222.

At step 222, the system constructs a deal structure and evaluates it against a pricing grid to determine applicable interest rates, fee structures, and loan terms, discussed in greater detail later. The deal structure incorporates the approved program parameters, the applicant's credit profile, the requested loan characteristics, and any applicable adjustments or overlays. At step 224, the system determines whether the constructed deal structure satisfies the pricing rules and constraints defined within the pricing grid. If the deal structure rules are not met, the method 200 may route the application toward a counteroffer output at step 228 with modified terms, or toward a decline output at step 232.

At step 226, the system generates an approval output indicating that the application has satisfied all underwriting rules, program parameters, and pricing grid requirements, as elaborated upon in later. At step 227, the automated approval output is sent to the customer electronically (via, for example, text and/or through an app) and to the dealer via, for example, an email. The approval may include the approved loan terms, interest rate, fee structure, and/or any applicable conditions or stipulations.

At step 228, the system generates a counteroffer output proposing modified loan terms under which the application could be approved. At step 234, an automated counteroffer is sent to the customer electronically (via, for example, text and/or through an app) and to the dealer via, for example, an email. The counteroffer output may include adjustments to the loan amount, interest rate, down payment requirement, and/or other deal structure parameters that would bring the application into compliance with the applicable underwriting rules and pricing grid constraints.

At step 230, the system generates a pend out output indicating that the application requires additional information or manual review before a final decision can be rendered. At step 232, the system generates a decline output indicating that the application does not satisfy the applicable underwriting criteria, as discussed in further detail in later. The automated decline output 233 may be sent via email and mailed to the vendor for the applicant. The decline output may include one or more reason codes identifying the specific rules or parameters that the application failed to meet.

Taken together, the steps of the automated underwriting and pricing method 200, from application submission at step 202 through decisioning output generation at steps 226, 228, 230, and 232, define a complete, end-to-end pipeline for evaluating loan applications without requiring manual underwriter intervention. The method 200 applies configurable rules, program parameters, and pricing grids in a deterministic, sequential manner, ensuring consistency, auditability, and rapid processing across all applications received by the system architecture 300.

### Pre-Bureau and Post-Bureau Rules Architecture

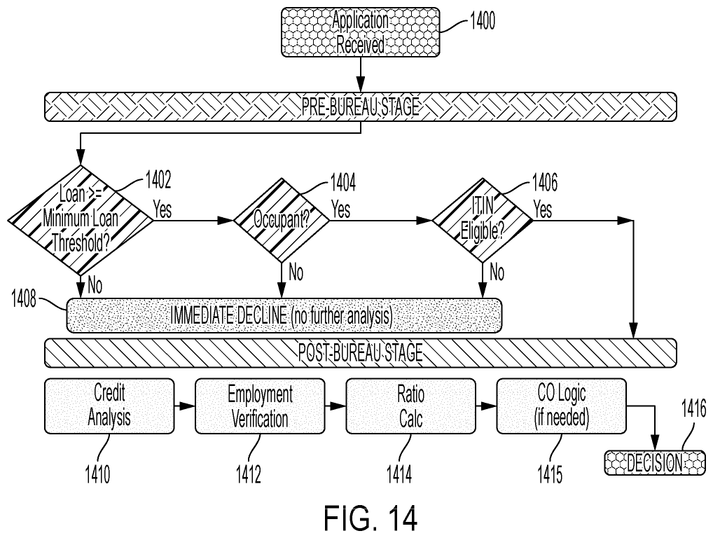

FIG. 14 illustrates a pre-bureau and post-bureau rules architecture in accordance with one or more embodiments of the present disclosure. The rules architecture employs a two-phase evaluation design in which a first set of rules (pre-bureau rules) is applied to the application data prior to initiating a credit bureau pull, and a second set of rules (post-bureau rules) is applied after credit report data has been retrieved and ingested. This two-phase approach improves processing efficiency by enabling the system to identify and decline clearly ineligible applications before incurring the computational cost and latency associated with a credit bureau inquiry, while reserving more data-intensive evaluations for the post-bureau phase when complete credit profile information is available.

The pre-bureau phase receives application input data 1400 and applies three sequential checks to determine baseline eligibility. At step 1402, the system evaluates whether the requested loan amount meets or exceeds a minimum loan amount threshold defined for the applicable lending program. If the requested loan amount falls below the minimum threshold, the application is routed to an immediate decline output at step 1408. At step 1404, the system evaluates whether the property will be owner-occupied by the borrower, as certain lending programs restrict eligibility based on occupancy status. If the occupancy requirement is not satisfied, the application is routed to the immediate decline output at step 1408. At step 1406, the system determines whether the applicant is an Individual Taxpayer Identification Number (ITIN) borrower, and if so, whether the originating lending partner has opted in to the ITIN borrower program. If the applicant is identified as an ITIN borrower and the lending partner has not opted in to the ITIN program, the application is routed to the immediate decline output at step 1408.

It should be noted that in certain embodiments, even when an application fails one or more pre-bureau rules and is routed to the immediate decline output at step 1408, the system may nonetheless initiate a hard credit pull against the applicant's credit profile. This behavior ensures that a credit inquiry record is established for compliance and audit trail purposes, regardless of the pre-bureau decisioning outcome. The credit pull result in such cases is stored in the relational database 308 but is not utilized for further underwriting evaluation of the declined application.

The post-bureau phase is initiated after the application has passed all pre-bureau rules and credit report data has been retrieved via the credit bureau API 312. At step 1410, the system performs a tradeline analysis on the applicant's credit report. The tradeline analysis processes each tradeline by type, including installment tradelines, revolving credit accounts, student loan tradelines, mortgage and HELOC tradelines, collection accounts, and derogatory items, applying the tradeline-specific processing rules. The tradeline analysis computes the borrower's total monthly debt obligations based on the parsed tradeline data.

At step 1412, the system evaluates employment and income information provided in the application. The employment and income verification examines factors such as the borrower's stated employment status, length of employment history, income amount, and income source classification. Certain lending programs impose minimum employment duration requirements, as described in the program branch criteria.

At step 1414, the system calculates three financial ratios using the combined application and credit data: a housing expense ratio (HR), a debt-to-income (DTI) ratio, and a loan-to-value (LTV) ratio. The housing expense ratio is computed as total proposed housing expense (including lot rent where applicable) divided by gross monthly income. The debt-to-income ratio is computed as total proposed housing expense plus total monthly debt obligations divided by gross monthly income. The loan-to-value ratio is computed as the loan amount divided by the maximum loanable value determined per the chattel-specific LTV calculation. Each ratio is compared against threshold values defined for the applicable program branch. If one or more ratios exceed their respective thresholds but fall within a counteroffer-eligible range, the system may generate a counteroffer output proposing modified loan terms that would bring the ratios within acceptable bounds. If the ratios exceed the maximum permissible limits, the application is routed toward decline.

At step 1415, the system evaluates whether counteroffer logic is applicable based on the results of the ratio calculations at step 1414 and the down payment verification. If the stated down payment is below the program branch minimum while all ratios pass their respective thresholds, the system flags the application for Counteroffer Type 1 processing. If the stated down payment meets or exceeds the program branch minimum but one or more ratios fail within the applicable boundary tolerance range, the system flags the application for Counteroffer Type 2 processing. If counteroffer logic is not triggered (either because all criteria pass or because ratio failures exceed the boundary tolerances), the application proceeds directly to decision routing at step 1416. The counteroffer processes themselves are described in detail later.

At step 1416, the system performs decision routing based on the aggregate results of the tradeline analysis at step 1410, the employment and income evaluation at step 1412, and the ratio calculations at step 1414. The decision routing logic synthesizes the individual rule evaluation outcomes into a composite determination that routes the application to one of the downstream processing stages of the method 200 (FIG. 2), including continuation to deal structure and pricing evaluation at step 222, counteroffer generation at step 228, pend out at step 230, or decline at step 232. The decision routing at step 1416 thus serves as the gateway between the post-bureau rules phase and the subsequent deal structure and pricing phases of the automated underwriting pipeline.

### ITIN Borrower Processing

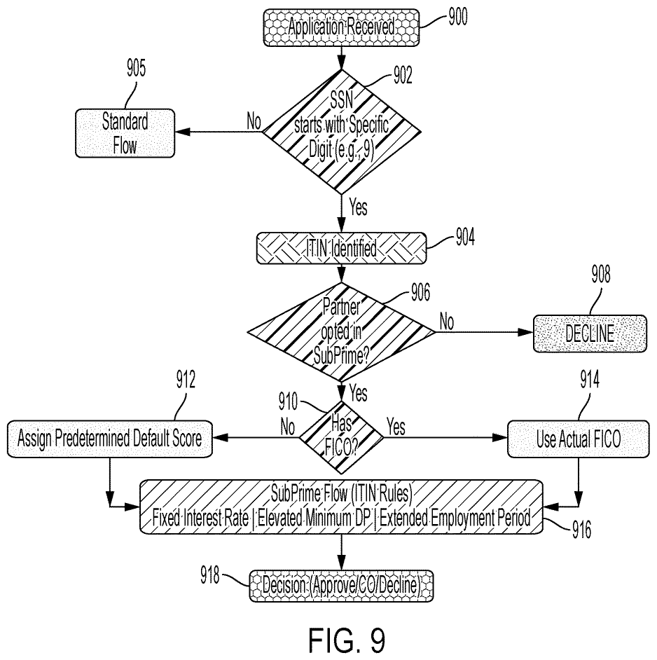

FIG. 9 illustrates a method for identifying and processing Individual Taxpayer Identification Number (ITIN) borrowers in accordance with one or more embodiments of the present disclosure. At step 900, at application is received, and at step 902, the system performs a format check on the identification number provided by the applicant. Specifically, the system examines whether the identification number begins with a specific digit (e.g., the digit 9) that identifies the number as an ITIN rather than a standard SSN. Upon detecting that the provided identification number begins with the specific digit, the system, at step 904, flags the application for ITIN-specific processing. Otherwise, at step 905, the system proceeds with the standard application flow.

At step 906, the system verifies whether the originating lending partner has opted in to the ITIN borrower program. The ITIN borrower program is an optional program that lending partners may elect to participate in, and participation is recorded as a configuration parameter associated with each lending partner within the relational database 308. If the lending partner has not opted in to the ITIN program, the application is routed to a decline output at step 908, as the system is not authorized to underwrite ITIN borrower applications on behalf of non-participating partners. If the lending partner has opted in, the method proceeds to evaluate the applicant's credit profile.

At step 910, the system determines whether a FICO score is available for the ITIN borrower from the credit bureau response data. Because ITIN borrowers may have limited or no conventional credit history with the major credit bureaus, a FICO score may not be available for all ITIN applicants. If no FICO score is available, the system, at step 912, assigns a predetermined default credit score to the application for purposes of downstream underwriting evaluation. The predetermined default credit score is a configurable parameter that represents a conservative baseline credit assessment for applicants lacking a bureau-generated score. If a FICO score is available, the system, at step 914, utilizes the actual FICO score returned by the credit bureau. Regardless of whether the default score or the actual FICO score is used, at step 915, the system assigns the ITIN borrower application to a SubPrime lending program classification, which applies a distinct set of underwriting parameters and pricing adjustments tailored to the risk profile associated with ITIN borrower applications.

At step 916, the system applies ITIN-specific underwriting rules that impose additional or modified requirements relative to standard borrower applications. These ITIN-specific rules may include, without limitation: a fixed interest rate that is higher than the rate applicable to standard borrower applications with equivalent credit profiles; an elevated minimum down payment requirement expressed as a percentage of the property value; and an extended minimum employment history requirement that mandates a longer period of continuous employment than is for standard borrowers. These ITIN-specific rules are stored as configurable parameters within the relational database 308 and may be adjusted by system administrators without requiring modification to the underlying application code. Upon satisfying the ITIN-specific rules, the application proceeds to step 918, where it enters the standard underwriting evaluation pipeline (e.g., program parameter evaluation, deal structure, and pricing) alongside non-ITIN applications.

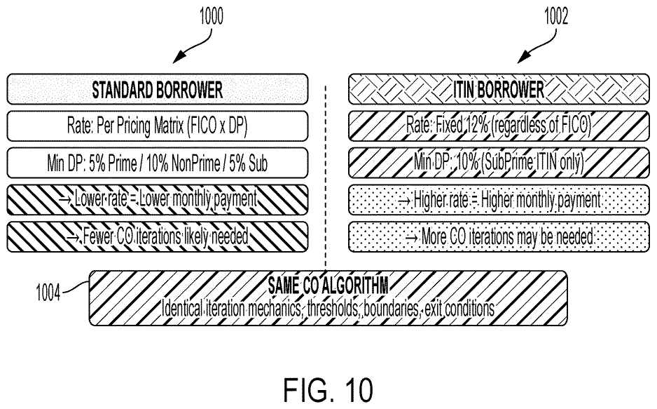

FIG. 10 illustrates a parallel processing architecture that enables both standard borrower applications and ITIN borrower applications to be evaluated using the same core counteroffer process 1004, while receiving different inputs and potentially producing different outcomes. On a first processing path, standard inputs 1000 (including standard credit scores, standard program parameters, and standard down payment and rate schedules) are provided to the counteroffer process 1004. On a second, parallel processing path, ITIN inputs 1002 (including the predetermined default credit score or actual FICO score as applicable, ITIN-specific program parameters, the fixed interest rate, and the elevated minimum down payment requirement) are provided to the same counteroffer process 1004.

The counteroffer process 1004 applies identical computational logic to both the standard inputs 1000 and the ITIN inputs 1002, thereby ensuring consistency across borrower categories. However, because the input parameters differ between the standard path and the ITIN path, the outputs may also differ. Standard outcome 1006 reflects the counteroffer terms generated using standard input parameters, while ITIN outcome 1008 reflects the counteroffer terms generated using ITIN-specific input parameters. This architecture ensures that ITIN borrowers are evaluated fairly using the same decisioning logic as standard borrowers, while the differences in input parameters (e.g., the elevated minimum down payment, the fixed interest rate, the predetermined default credit score) appropriately account for the distinct risk profile associated with ITIN borrower applications.

### Credit Report Processing

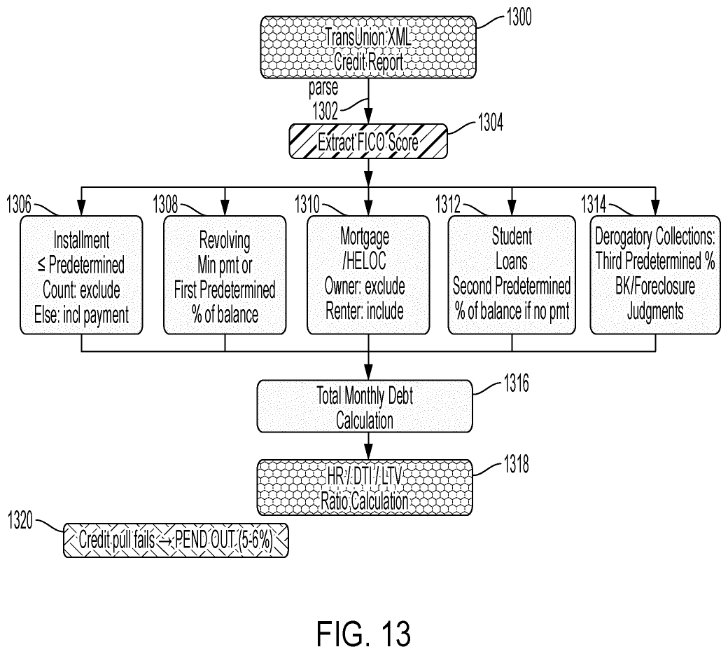

FIG. 13 illustrates a credit report processing pipeline utilized by the system. At step 1300, the system receives a credit report from a credit bureau computing system. The credit report contains structured data fields representing the borrower's complete credit history, including, for example, tradeline accounts, payment histories, outstanding balances, and/or public record information. At step 1302, the system parses the credit report to extract a credit score and to analyze a plurality of tradeline types, including, for example, installment tradelines, revolving tradelines, student loan tradelines, mortgage tradelines, home equity line of credit (HELOC) tradelines, collection tradelines, and/or derogatory tradelines. Individual data elements are extracted into normalized internal data structures suitable for automated analysis. The tradeline-specific processing rules for each type are described in the paragraphs that follow.

At step 1304, the system extracts the borrower's FICO score from the parsed credit report data. The FICO score serves as a primary input to the waterfall decision tree described herein and determines which program branch (e.g., prime, non-prime, or sub-prime) the application is routed to for underwriting evaluation.

At step 1306, the system processes installment tradelines identified in the credit report. For each installment account, the monthly payment amount reported by the creditor is included in the borrower's recurring debt obligations. However, installment tradelines with a remaining payment count at or below a predetermined count threshold (e.g., ten or fewer remaining payments) are excluded from the debt calculation, as these obligations will be extinguished in the near term and do not materially affect long-term repayment capacity.

At step 1308, the system processes revolving credit accounts. For each revolving account, a minimum monthly payment reported in the credit file is used. In cases where the credit file does not include a minimum payment amount for a revolving account, the system determines the monthly obligation as a first predetermined percentage of the outstanding balance. This approach ensures that revolving credit exposure is consistently captured even when creditor reporting is incomplete.

At step 1310, the system processes mortgage and home equity line of credit (HELOC) tradelines. The treatment of these obligations depends on the borrower's current residence status as stated on the loan application. If the borrower indicates on the application that they currently rent their residence, any mortgage tradeline appearing on the credit report is classified as an investment property obligation and included in total monthly debt. Conversely, if the borrower indicates that they currently own their residence, the mortgage payment is applied as the borrower's current housing expense rather than as an additional debt obligation. This application-driven classification is necessary because credit report data alone does not reliably distinguish between primary residence mortgages and investment property mortgages.

At step 1312, the system processes student loan tradelines. Student loans that are in a deferred status or enrolled in an income-based repayment (IBR) plan may report a zero-dollar monthly payment in the credit file. For such accounts, the system determines the monthly obligation as a second predetermined percentage of the total outstanding loan balance. This approach provides a conservative estimate of the borrower's future repayment burden upon conclusion of the deferral or IBR period.

At step 1314, the system processes collection accounts and selected specialized tradeline types. For collection accounts, the system determines a monthly obligation as a third predetermined percentage of the outstanding collection balance. Age-based disregards are applied, wherein applicable aging thresholds may vary by program branch. Collections associated with medical, dental, or business-related obligations are disregarded across all program branches. Additionally, 401(k) loan accounts are treated as installment debt using the borrower's stated monthly repayment amount, rather than as retirement account withdrawals, thereby ensuring that payroll deductions associated with 401(k) loan repayment are captured as recurring debt obligations in the borrower's overall debt profile.

At step 1316, the system aggregates all tradeline amounts from the preceding steps to compute the borrower's total monthly debt obligation. Derogatory items, including, for example, bankruptcies, foreclosures, charge-offs, repossessions, judgments and liens, and consumer credit counseling participation, are evaluated according to the program-specific waiting periods, recency rules, and treatment criteria for the assigned program branch.

At step 1318, the system calculates the borrower's key financial ratios: the housing ratio (HR), the debt-to-income ratio (DTI), and the loan-to-value ratio (LTV). The housing ratio is computed as total proposed housing expense (including lot rent where applicable per the land type classification as described herein) divided by gross monthly income. The debt-to-income ratio is computed as the sum of total proposed housing expense and total monthly debt obligations divided by gross monthly income. The loan-to-value ratio is computed as the loan amount divided by the maximum loanable value, where maximum loanable value is the lesser of a first predetermined percentage of the net dealer invoice plus ancillary costs, or a second predetermined percentage of the total sales price. These ratios serve as primary inputs to the rules engine for approval, counteroffer, or decline determinations.

At step 1320, the system identifies applications that require manual review and routes them to a pend-out queue. Approximately five to six percent of applications are routed to manual underwriting review due to conditions such as credit report retrieval failures, data anomalies, or edge cases that fall outside the automated rule parameters.

### Rules Engine Architecture: Waterfall Decision Tree

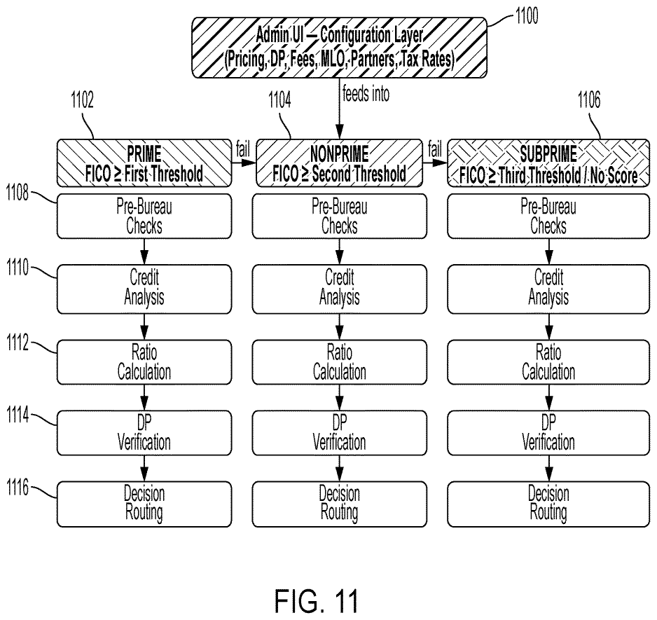

FIG. 11 illustrates the administrative configuration layer of the rules engine. At element 1100, an administrator accesses a configuration user interface that enables the definition and modification of underwriting parameters across three program branch columns. The configuration user interface is accessible to authorized personnel who may modify the rule parameters that govern automated lending decisions.

The three program branch columns are organized as follows: a prime column 1102, a non-prime column 1104, and a sub-prime column 1106. Each column defines a set of underwriting criteria specific to its risk tier, including credit score thresholds, maximum allowable ratios, and down payment requirements. The credit score thresholds are configured as generalized parameters (e.g., a first credit score threshold separating prime from non-prime applicants, and a second credit score threshold separating non-prime from sub-prime applicants) that may be adjusted by the administrator without requiring code changes.

Within each program branch column, the rules engine executes a sequential checklist of evaluation steps. At step 1108, a pre-bureau verification is performed, including one or more of a minimum loan amount threshold check, an occupant borrower verification, and an ITIN eligibility determination. At step 1110, the credit analysis step evaluates the borrower's credit profile against branch-specific criteria. At step 1112, the ratio calculation step determines whether the borrower's HR, DTI, and LTV ratios fall within the allowable ranges for that branch. At step 1114, the down payment verification step confirms that the borrower's proposed down payment meets or exceeds the branch minimum. At step 1116, the decision routing step directs the application to approval, counteroffer generation, or decline based on the cumulative results of the preceding steps.

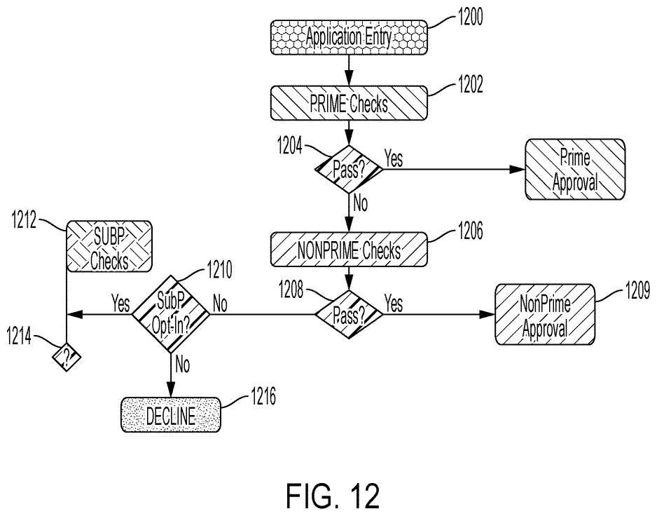

FIG. 12 illustrates the waterfall decision tree that governs application routing across the three program branches. At step 1200, the application enters the waterfall. The system first evaluates the application against the prime branch criteria at step 1202. At decision point 1204, if the application satisfies all prime branch requirements, the application is routed for prime approval or counteroffer processing.

If the application does not pass the prime branch evaluation at step 1204, the system cascades the application to the non-prime branch at step 1206. The non-prime branch applies its own set of underwriting criteria, which are less restrictive than the prime criteria but still require minimum credit quality and ratio thresholds. At decision point 1208, if the application satisfies the non-prime requirements, it is routed for non-prime approval or counteroffer processing, at step 1209.

If the application does not pass the non-prime evaluation at step 1208, the system evaluates whether the applicable lending partner has opted in to sub-prime consideration at step 1210. If the partner has opted in, the application proceeds to sub-prime underwriting checks at step 1212. At decision point 1214, if the application satisfies the sub-prime criteria, it is routed for sub-prime approval or counteroffer processing. If the application fails the sub-prime evaluation, or if the partner did not opt in to sub-prime consideration, the application is routed to decline at step 1216.

The waterfall architecture ensures that each application is evaluated against the most favorable program branch first. By evaluating the prime branch before the non-prime branch, and the non-prime branch before the sub-prime branch, the system maximizes the likelihood that a qualified borrower receives the best available terms. This sequential evaluation also prevents an application from being simultaneously approved under multiple branches, thereby enforcing mutual exclusivity of program assignment.

Each program branch further utilizes a scoring matrix that cross-references the borrower's FICO score against the proposed down payment percentage to determine the applicable interest rate. This scoring matrix is configurable through the administrative user interface at element 1100, allowing the lending institution to adjust rate tiers in response to market conditions or risk appetite changes without modifying the underlying decision logic.

### Manufactured Housing-Specific Underwriting Variables

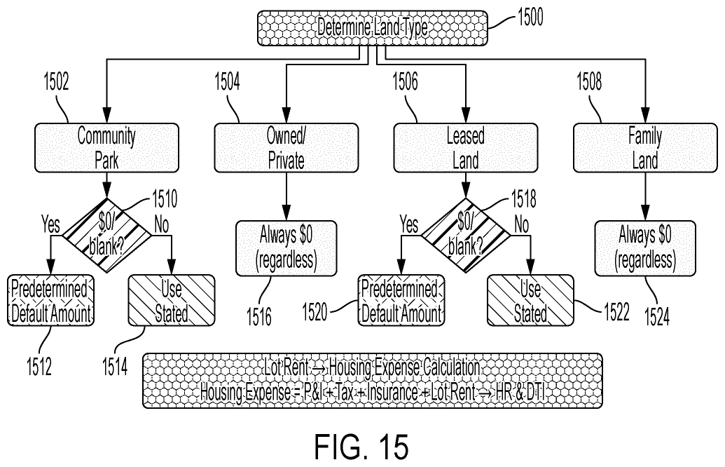

FIG. 15 illustrates the lot rent determination process. At step 1500, the system determines the land type associated with the manufactured home. The classification branches into four categories: community park 1502, owned or private land 1504, leased land 1506, and family-owned land 1508. The land type classification drives the method by which the borrower's lot rent obligation is calculated, as each category entails different cost structures.

For community park placements at step 1502, the system evaluates whether the borrower has provided a stated lot rent amount. At decision point 1510, if the lot rent field is blank, the system assigns a predetermined default amount at step 1512 to ensure that a housing expense is captured even when the borrower omits this information. If the borrower has provided a lot rent amount, the system uses the stated value at step 1514. For owned or private land at step 1504, the lot rent is set to zero at step 1516, as the borrower has no recurring land payment. For leased land at step 1506, a similar blank-check evaluation is performed at step 1518; if blank, a predetermined default amount for leased land is assigned at step 1520, and if stated, the provided value is used at step 1522. For family-owned land at step 1508, the lot rent is set to zero at step 1524.

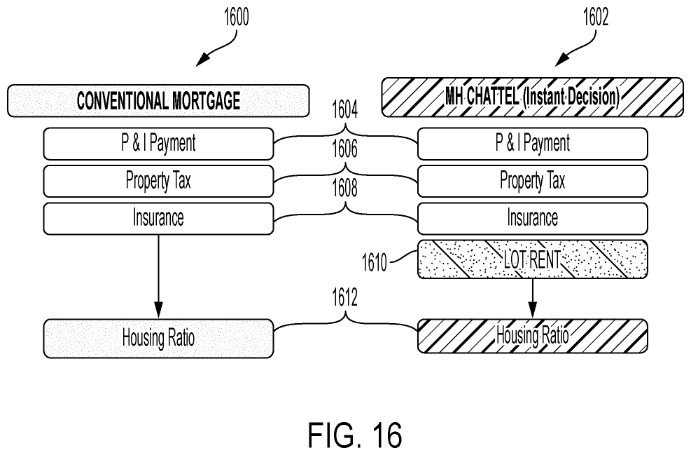

FIG. 16 provides a side-by-side comparison of housing expense components for a conventional mortgage column 1600 and a manufactured housing chattel loan column 1602. Both columns include principal and interest 1604, property taxes 1606, and insurance 1608. However, the chattel loan column 1602 additionally includes a lot rent component 1610, which is unique to manufactured housing finance. This lot rent component reflects the recurring cost of land use that chattel loan borrowers incur when they do not own the underlying land.

The total housing expense for a manufactured housing chattel loan is therefore computed as the sum of principal and interest, property taxes, insurance, and lot rent. The inclusion of lot rent in the housing expense calculation is significant because it directly affects the borrower's housing ratio 1612 and, consequently, the automated underwriting outcome. Conventional mortgage underwriting does not account for lot rent, making this component a distinguishing feature of the manufactured housing underwriting module.

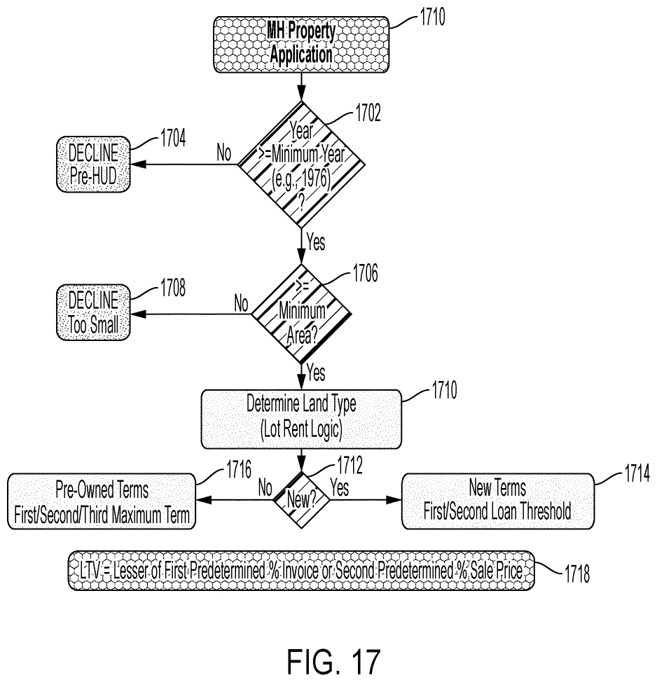

FIG. 17 illustrates the chattel loan-to-value (LTV) calculation process. At step 1700, the system receives manufactured home property inputs including home specifications, pricing data, and ancillary costs. At step 1702, the system verifies that the home was manufactured in or after 1976, ensuring compliance with the HUD Code for manufactured housing construction standards. If not, at step 1704, the application is declined. At step 1706, the system verifies that the home meets a minimum area requirement (e.g., as defined by American National Standards Institute or Building Officials and Code Administrators standards), with approved exceptions for park models and tiny homes. If not, at step 1708, the application is declined.

Otherwise, at step 1710, the system evaluates the land type classification to determine applicable LTV parameters. At step 1712, the system classifies the home as new or pre-owned, as each condition carries different valuation treatment. If new, at step 1714, the system applies term tiers that define maximum loan terms based on the combination of land type, home condition, and home specifications. These term tiers ensure that loan duration is proportional to the expected useful life and collateral characteristics of the manufactured home. If pre-owned, at step 1716, the system applies pre-owned terms.

At step 1718, the system computes the chattel LTV as the lesser of two values: (a) a first predetermined percentage of the net dealer invoice plus options, taxes, setup costs, and closing costs, or (b) a second predetermined percentage of the total sale price. The net dealer invoice is defined as the wholesale cost paid by the dealer for the manufactured home unit, exclusive of markup, dealer profit, and optional add-ons. This dual-formula approach constrains the LTV to protect the lender against over-advancement relative to both the wholesale cost basis and the retail transaction price.

The system enforces property classification requirements for manufactured homes based on several criteria. Home age verification requires that the manufactured home was constructed after 1976 to comply with HUD Code construction standards. Minimum area requirements are evaluated against applicable ANSI and BOCA standards. The system further classifies the home as new or pre-owned, which affects both the applicable LTV calculation and the maximum loan term.

Occupancy classification requires that the subject property be owner-occupied as a primary residence for the standard program branches. However, the prime program branch permits financing of vacation homes and second homes with an elevated down payment requirement. This exception recognizes that creditworthy borrowers in the prime tier may seek manufactured housing for seasonal or secondary use, while maintaining risk controls through increased equity participation.

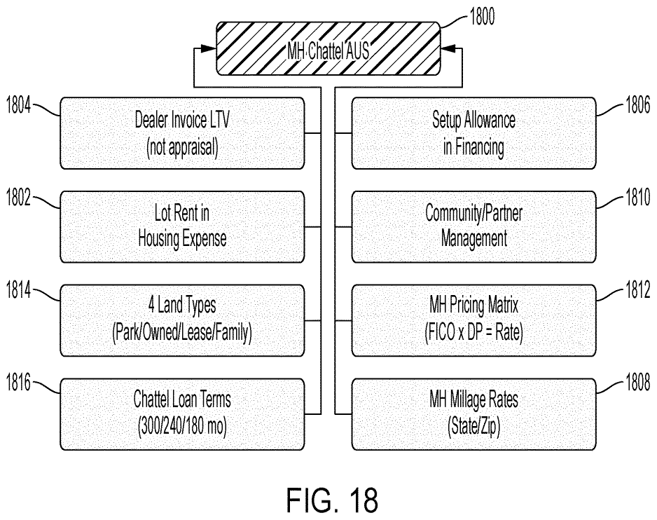

FIG. 18 illustrates the range of manufactured housing-specific underwriting variables that the system incorporates. A central hub 1800 represents the core manufactured housing underwriting engine, with eight differentiating features arranged as spokes, each of which has no counterpart in conventional real estate mortgage processing.

Spoke 1802 implements the lot rent in housing expense feature, incorporating lot rent as a component of the borrower's total housing expense calculation as described in connection with FIG. 15. Spoke 1804 implements the dealer invoice LTV calculation, computing the loan-to-value ratio based on dealer invoice pricing rather than real property appraisal as described in connection with FIG. 17. Spoke 1806 provides the setup allowance in financing feature, which includes manufactured home delivery, foundation, and installation costs in the financeable loan amount. Spoke 1808 provides the MH millage rate feature, maintaining a database of manufactured housing-specific property tax rates by state and postal code for use in housing expense and ratio calculations.

Spoke 1810 provides the community partner management feature, which tracks which manufactured housing communities and dealer partners are approved and which loan programs each is eligible for. Spoke 1812 provides the MH pricing matrix feature, which maps the borrower's credit score and down payment percentage to an applicable interest rate using a configurable scoring matrix specific to manufactured housing chattel lending. Spoke 1814 provides the four land types feature, implementing the land type classification system (community park, owned/private land, leased land, and family land) that drives lot rent determination and other land-type-specific processing. Spoke 1816 provides the chattel loan terms feature, applying manufactured housing-specific loan term tiers based on home condition (new versus pre-owned) and loan amount thresholds.

The central hub 1800 coordinates the data flow among the specialized features, ensuring that downstream calculations (such as ratio evaluation) receive the correct aggregated inputs from all upstream features.

### Counteroffer Generation

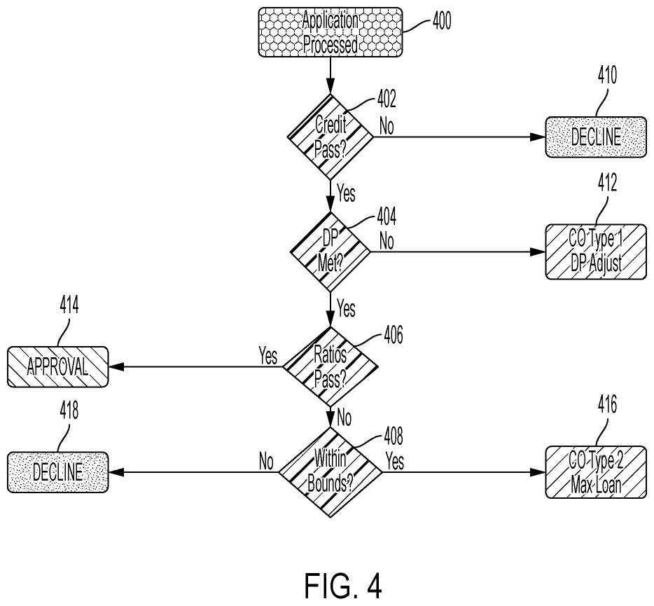

FIG. 4 illustrates the counteroffer decision routing process. At step 400, the application has been processed through the credit report pipeline and the waterfall decision tree. At step 402, the system evaluates whether the borrower's credit profile passes the assigned program branch's credit criteria. If the credit criteria are not satisfied, the application is routed to decline at step 410, as credit deficiencies cannot be remedied through counteroffer adjustments to loan terms.

If the credit check passes at step 402, the system evaluates the borrower's down payment at step 404. If the proposed down payment is below the program branch minimum, the application is routed to Counteroffer Type 1 processing at step 412, which applies a down payment adjustment process. If the down payment meets the minimum requirement, the system proceeds to evaluate the borrower's financial ratios at decision point 406. If all ratios pass, the application is routed to approval at step 414.

If one or more ratios do not pass at step 406, the system evaluates whether the failing ratios fall within a boundary tolerance zone at step 408. If the ratios are within the tolerance boundaries, the application is routed to Counteroffer Type 2 processing at step 416, which applies a ratio correction process. If the ratios exceed the tolerance boundaries, the application is routed to decline at step 418, as the deviation from acceptable parameters is too large to be corrected through incremental adjustments.

The sequential evaluation order of decision points 402, 404, 406, and 408 ensures mutual exclusivity among the possible outcomes. Each application follows exactly one path through the routing logic, resulting in exactly one of the following dispositions: decline due to credit failure, Counteroffer Type 1 generation, full approval, Counteroffer Type 2 generation, or decline due to boundary exceedance. This mutual exclusivity prevents conflicting or redundant counteroffer determinations.

### Counteroffer Type 1: Down Payment Adjustment

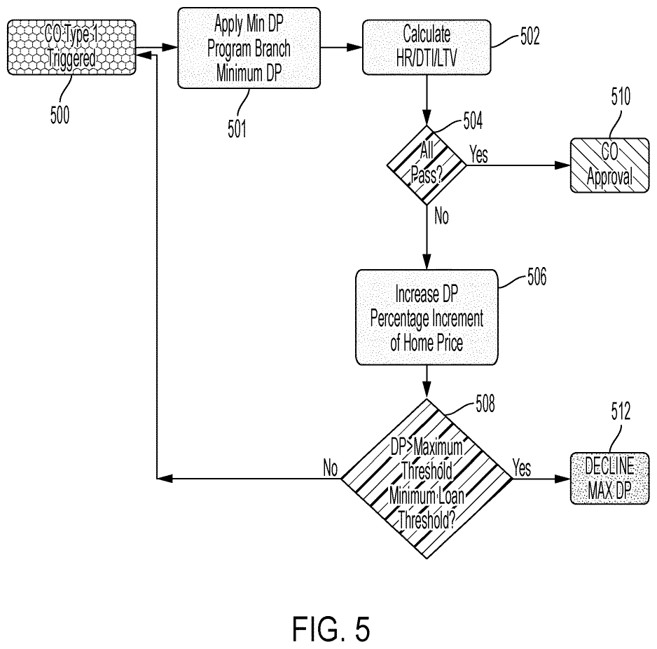

FIG. 5 illustrates the Counteroffer Type 1 process, at step 500, which adjusts the borrower's down payment to achieve compliant financial ratios. At step 501, the system applies the minimum down payment required by the assigned program branch. At step 502, the system recalculates the borrower's financial ratios based on the adjusted down payment, since increasing the down payment reduces the loan amount and thereby affects the principal and interest component of the housing expense.

At step 504, the system evaluates three financial ratios in parallel. The housing ratio (HR) is defined as total proposed housing expense (including lot rent where applicable) divided by gross monthly income. The debt-to-income ratio (DTI) is defined as the sum of total proposed housing expense and total recurring monthly debt divided by gross monthly income. The loan-to-value ratio (LTV) is defined as the loan amount divided by the maximum loanable value, where maximum loanable value is the lesser of a first predetermined percentage of the net dealer invoice plus ancillary costs, or a second predetermined percentage of the total sales price, as described herein. All three ratios must simultaneously satisfy the thresholds defined for the assigned program branch.

If all three ratios pass at step 504, the application is routed to counteroffer approval at step 510, and the system generates a counteroffer reflecting the adjusted down payment and corresponding loan terms. If one or more ratios fail, the system proceeds to step 506, where it increases the down payment by a predetermined percentage increment of the home price. The process then loops back to step 502 to recalculate the ratios with the further-increased down payment.

At step 508, the system evaluates exit conditions to prevent infinite iteration. If the cumulative down payment exceeds a maximum down payment threshold, or if the resulting loan amount falls below a minimum loan amount floor, the process terminates and the application is routed to decline at step 512. These exit conditions ensure that the system does not generate counteroffers requiring unreasonably large down payments or resulting in loan amounts that are uneconomical to originate.

### Counteroffer Type 2: Ratio Correction

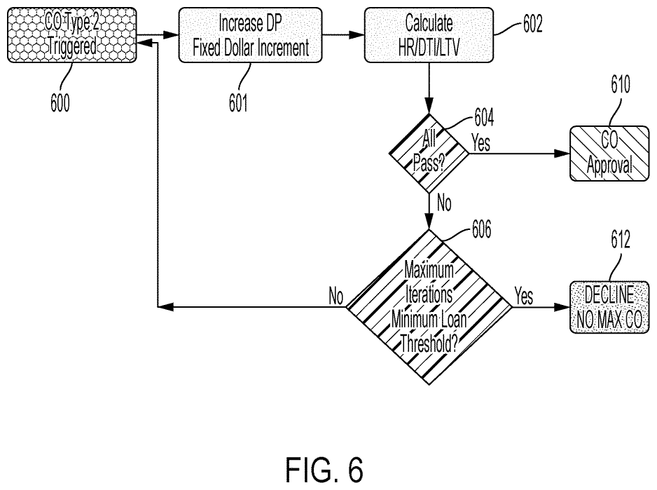

FIG. 6 illustrates the Counteroffer Type 2 process, at step 600, which incrementally adjusts the loan terms to bring financial ratios into compliance. At step 601, the system increases the down payment by a fixed dollar increment. Unlike the Counteroffer Type 1 process, which uses a percentage-based increment, the Type 2 process uses a fixed dollar amount per iteration. At step 602, the system recalculates all financial ratios based on the adjusted down payment and resulting loan amount.

At step 604, the system evaluates whether all financial ratios now satisfy the program branch thresholds. If all ratios pass, the application is routed to counteroffer approval at step 610, and the system generates a counteroffer with the adjusted terms. If one or more ratios remain non-compliant, the process proceeds to evaluate exit conditions.

Two exit conditions govern termination of the Type 2 process. At step 606, the system checks whether the maximum number of iterations has been reached and whether the resulting loan amount has fallen below the minimum loan amount floor. If either condition is met, the process terminates and the application is routed to decline at step 612. If neither exit condition is met, the process loops back to step 600 for another fixed-dollar increment.

The distinction between fixed-dollar increments (Type 2) and percentage-based increments (Type 1) reflects the different failure conditions that trigger each process. The Type 1 process addresses applications where the down payment is below the program minimum; the percentage-based increment adjusts the down payment proportionally relative to the home price. The Type 2 process addresses applications where the ratios are marginally out of compliance within the boundary tolerance range; the fixed-dollar increment incrementally reduces the loan amount to bring ratios below the applicable thresholds.

### Boundary Tolerance Zones

The counteroffer decision routing at step 408 (FIG. 4) relies on boundary tolerance zones that define the range within which a failing ratio is eligible for counteroffer correction versus outright decline. Each financial ratio is associated with three zones: a pass zone, a counteroffer-eligible zone, and a hard decline zone. The pass zone encompasses ratio values at or below the primary threshold for the assigned program branch. The counteroffer-eligible zone encompasses ratio values that exceed the primary threshold but remain at or below a tolerance threshold. The hard decline zone encompasses ratio values that exceed the tolerance threshold.

The following table summarizes the boundary tolerance zone structure for the three financial ratios:

TABLE 1

| Ratio | Pass Zone | CO-Eligible Zone | Hard Decline Zone |
|---|---|---|---|
| Housing Ratio | At or below | Above primary | Above |
| (HR) | primary | threshold, at or | tolerance |
| | threshold | below tolerance | threshold |
| | | threshold | |
| Debt-to-Income | At or below | Above primary | Above |
| (DTI) | primary | threshold, at or | tolerance |
| | threshold | below tolerance | threshold |
| | | threshold | |
| Loan-to-Value | At or below | Above primary | Above |
| (LTV) | primary | threshold, at or | tolerance |
| | threshold | below tolerance | threshold |
| | | threshold | |

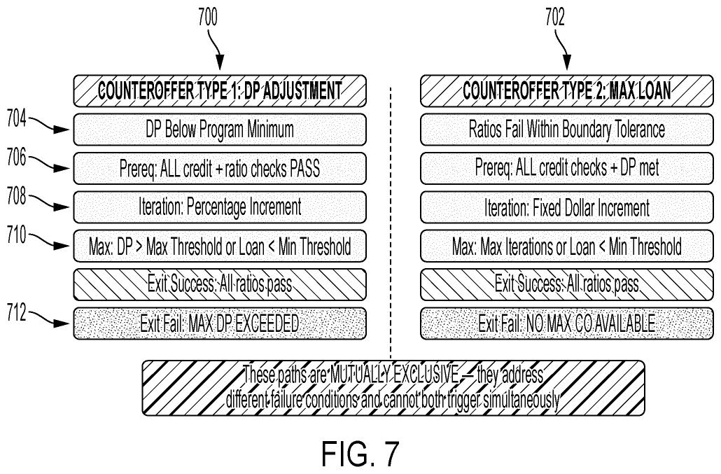

FIG. 7 provides a comparative summary of the Counteroffer Type 1 and Counteroffer Type 2 processes. A Type 1 column 700 and a Type 2 column 702 are organized along several comparison dimensions. Row 704 identifies the trigger conditions: Type 1 is triggered when the proposed down payment falls below the program branch minimum, while Type 2 is triggered when one or more ratios fall within the boundary tolerance zone. Row 706 identifies the prerequisites: Type 1 requires that the borrower's credit profile has already passed the branch criteria, and Type 2 additionally requires that the down payment meets or exceeds the branch minimum.

Row 708 describes the iteration mechanics: Type 1 applies a predetermined percentage increment of the home price per iteration, while Type 2 applies a fixed dollar increment per iteration. Row 710 describes the exit conditions: both processes terminate if the resulting loan amount falls below the minimum floor, but Type 1 additionally terminates if the cumulative down payment exceeds a maximum threshold, while Type 2 terminates if a maximum iteration count is reached. Row 712 confirms the mutual exclusivity of the two processes; an application is routed to exactly one process type based on the decision routing logic of FIG. 4.

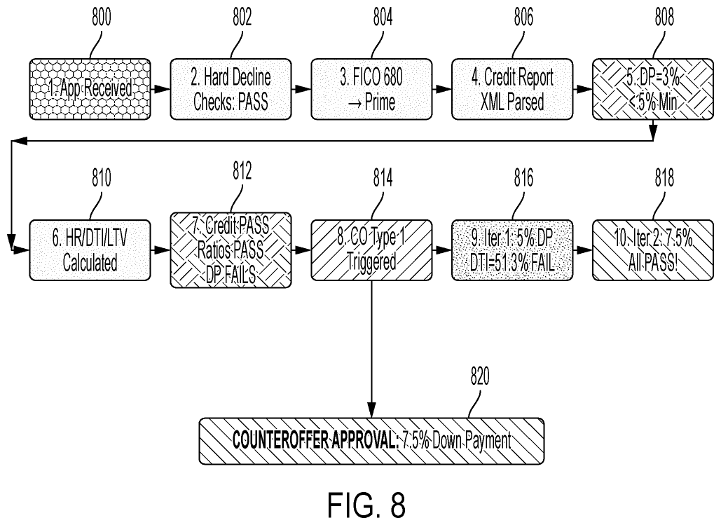

FIG. 8 illustrates the end-to-end application flow from initial submission through final disposition. At step 800, the borrower submits a loan application through the digital interface. At step 802, the system performs pre-bureau checks including a minimum loan amount threshold check, an occupant borrower verification, and an ITIN eligibility determination. At step 804, the system initiates an automated credit pull from the credit bureau computing system, receiving the XML credit report described in connection with FIG. 13. The specific numerical values and processing outcomes depicted in FIG. 8 correspond to Example 1 described below.

At step 806, the system assigns the application to a program branch using the waterfall decision tree described in connection with FIG. 12. At step 808, the credit analysis module evaluates the borrower's credit profile against the branch-specific criteria. At step 810, the system calculates the borrower's financial ratios (HR, DTI, LTV). At step 812, the system evaluates the borrower's down payment against the branch minimum requirement.

At step 814, the system determines whether a counteroffer is triggered based on the decision routing logic of FIG. 4. If a counteroffer is required, the system enters the applicable process. At step 816, the first iteration of the counteroffer process is executed with adjusted loan terms. At step 818, subsequent iterations are performed as needed until either the ratios are brought into compliance (resulting in counteroffer approval, at step 820) or an exit condition is reached (resulting in decline). The end-to-end flow demonstrates how the individual modules operate in concert to produce a fully automated lending decision.

As described in connection with FIGS. 4 through 8, the system enforces mutual exclusivity at multiple levels. At the program branch level, the waterfall decision tree ensures that each application is assigned to exactly one branch. At the counteroffer level, the decision routing logic ensures that each application is directed to at most one counteroffer process type. At the disposition level, each application receives exactly one final outcome: approval, counteroffer approval, or decline. This layered mutual exclusivity prevents conflicting decisions, simplifies audit and compliance review, and ensures deterministic behavior of the automated underwriting system.

### Example 1: Counteroffer Type 1 (First Program Branch)

The following example illustrates a complete ten-step walkthrough of the decision engine processing an application that results in a Counteroffer Type 1 adjustment. In this scenario, a borrower applies for a manufactured home chattel loan and is assigned to the first program branch (Prime). All financial ratios pass their respective thresholds; however, the stated down payment is below the program minimum, triggering the Counteroffer Type 1 process.

Step 1 (Application Submission): A borrower submits a loan application via the Lender Portal for a manufactured home situated in a Community Park. The application specifies the following initial parameters: home price, a stated down payment of 3%, and borrower income and expense information. The application data is received by the decision engine and queued for automated processing.

Step 2 (Pre-Bureau Eligibility Checks): The system performs the pre-bureau eligibility checks described earlier. The loan amount exceeds the $25,000 minimum threshold (pass). An occupant borrower is confirmed (pass). The Social Security Number does not begin with the digit 9, confirming the borrower is not an ITIN applicant (pass). All pre-bureau checks pass, and the application proceeds to credit report retrieval.

Step 3 (Credit Report Retrieval): The system transmits an API call to the credit bureau computing system requesting the borrower's credit report. The credit report is received in response and parsed by the decision engine.

Step 4 (FICO Score Extraction and Program Branch Assignment): A FICO score of 680 is extracted from the parsed XML credit report. The score of 680 meets the first program branch threshold of 660 minimum. The application is assigned to the first program branch (Prime). No waterfall cascade is required.

Step 5 (Full Credit Report Analysis): The full XML credit report is parsed according to the rules described herein. All tradeline types are analyzed using first program branch rules, including installment, revolving, student loan, mortgage, HELOC, collection, and derogatory tradelines. Monthly debt obligations are computed from the parsed tradeline data.

Step 6 (Waterfall Cascade Evaluation): All first program branch credit checks are passed. The waterfall cascade mechanism described herein is not triggered. The application remains assigned to the first program branch. No cascade to the second program branch or the third program branch is required.

Step 7 (Manufactured Housing Specific Ratio Calculation): The system performs manufactured housing specific ratio calculations as described herein. The land type is classified as Community Park, and the applicable lot rent logic of FIG. 15 is applied to determine the lot rent component of the housing expense. Because a nonzero lot rent value is stated on the application, the system uses the stated amount (element 1514) rather than the predetermined default (element 1512). The loan-to-value ratio is calculated using the dealer invoice methodology described herein. All three ratios (housing ratio, debt-to-income ratio, and loan-to-value ratio) are computed with manufactured housing specific inputs, including the lot rent component in the housing expense calculation.

Step 8 (Counteroffer Type 1 Trigger): All three financial ratios pass their respective thresholds. However, the stated down payment of 3% is below the first program branch minimum of 5%. The Counteroffer Type 1 process is triggered per FIG. 4, element 412.

Step 9 (Iteration 1): The system applies the first program branch minimum down payment of 5%. The financial ratios are recalculated: housing ratio=38%, debt-to-income ratio=51.3%, loan-to-value ratio=99.8%. The debt-to-income ratio of 51.3% exceeds the 50% threshold. This iteration fails.

Step 10 (Iteration 2): The system increases the down payment to 7.5%. The financial ratios are recalculated: housing ratio=38%, debt-to-income ratio=49.7%, loan-to-value ratio=98.5%. All three ratios are at or below their respective thresholds. The counteroffer is approved with a required down payment of 7.5%.

Table 2 below summarizes the iterations performed by the Counteroffer Type 1 process for this example:

TABLE 2

| | Down | | | | |
|---|---|---|---|---|---|
| Iteration | Payment | HR | DTI | LTV | Result |
| Initial | 3% | — | — | — | Below minimum DP |
| 1 | 5% | 38% | 51.3% | 99.8% | DTI fails |
| 2 (Final) | 7.5% | 38% | 49.7% | 98.5% | All pass; CO approved |

Example 2: Counteroffer Type 2 (Second Program Branch with Waterfall Cascade)

The following example illustrates a processing scenario in which the waterfall cascade mechanism assigns the application to the second program branch (NonPrime), and the Counteroffer Type 2 process is triggered to iteratively adjust the down payment amount.

Application Parameters: The borrower's FICO score is 620. The home price is $70,000. The stated down payment is $7,000 (10%). The gross monthly income is $3,800.

Program Branch Assignment via Waterfall Cascade: The FICO score of 620 fails the first program branch threshold of 660. The waterfall cascade is triggered. The score is evaluated against the second program branch threshold of 580. The score of 620 meets the second program branch threshold. The application is assigned to the second program branch (NonPrime). No further cascade is required.

Initial Ratio Computation: The system computes the initial financial ratios using the stated application parameters: down payment=$7,000, loan amount=$63,000, housing ratio=41%, debt-to-income ratio=52%, loan-to-value ratio=90%. The debt-to-income ratio of 52% exceeds the applicable threshold but falls within the boundary tolerance range (50% to 63%). The Counteroffer Type 2 process is triggered.

Iteration 1: The system increases the down payment by a fixed dollar increment to $9,000. The loan amount is reduced to $61,000. The ratios are recalculated: housing ratio=40%, debt-to-income ratio=51%, loan-to-value ratio=87.1%. The debt-to-income ratio of 51% still exceeds the threshold. This iteration fails.

Iteration 2: The system increases the down payment to $11,000. The loan amount is reduced to $59,000. The ratios are recalculated: housing ratio=39%, debt-to-income ratio=49%, loan-to-value ratio=84.3%. All three ratios are at or below their respective thresholds. The counteroffer is approved with a required down payment of $11,000.

Table 3 below summarizes the iterations performed by the Counteroffer Type 2 process for this example:

TABLE 3

| | Down | Loan | | | | |
|---|---|---|---|---|---|---|
| Iteration | Payment | Amount | HR | DTI | LTV | Result |
| Initial | $7,000 | $63,000 | 41% | 52% | 90% | DTI fails |
| | | | | | | (within |
| | | | | | | boundary) |
| 1 | $9,000 | $61,000 | 40% | 51% | 87.1% | DTI fails |
| 2 (Final) | $11,000 | $59,000 | 39% | 49% | 84.3% | All pass; CO |
| | | | | | | approved |

### Example 3: ITIN Borrower End-to-End Processing

The following example illustrates the complete end-to-end processing path for an Individual Taxpayer Identification Number (ITIN) borrower. ITIN borrowers are subject to specialized processing rules, including automatic assignment to the sub-prime program branch, a fixed interest rate, an elevated minimum down payment requirement, and enhanced employment history verification. The higher fixed interest rate produces larger monthly payment amounts, which may require additional counteroffer iterations to bring the ratios below applicable thresholds.

ITIN Detection and Partner Validation: The borrower submits a loan application. The system detects that the borrower identification number begins with the digit 9, identifying the borrower as an ITIN applicant (FIG. 9, element 900). The system performs a partner opt-in check at element 902 and confirms that the originating partner has opted into the sub-prime program with ITIN lending enabled. The application proceeds to credit report retrieval.

Credit Report and Score Assignment: The system retrieves a credit report from the credit bureau computing system. No FICO score is returned for the ITIN borrower. Per the ITIN processing rules described earlier, a predetermined default credit score is assigned to the application at element 908. The application is assigned to the sub-prime program branch at element 912, regardless of any score value, as required by the ITIN processing pathway.

ITIN-Specific Rules Application: The following ITIN-specific rules are applied at element 914: a fixed interest rate is assigned (overriding any rate that would otherwise be determined by the scoring matrix); an elevated minimum down payment percentage is required; and an extended employment history requirement is verified against the borrower's stated employment data.

Ratio Calculation and Counteroffer Eligibility: The system computes the initial financial ratios using the stated application parameters, the fixed interest rate, and sub-prime program branch rules. Because the fixed interest rate applicable to ITIN borrowers is higher than rates available under other program branches, the resulting monthly payment is correspondingly larger, which increases the housing ratio and debt-to-income ratio relative to a similarly situated non-ITIN borrower. If one or more ratios fail but remain within the applicable boundary tolerance range, the system evaluates whether a Counteroffer Type 2 adjustment is viable. The counteroffer process operates identically for ITIN and non-ITIN borrowers; however, the elevated interest rate and minimum down payment floor may cause the process to require additional iterations or to reach a decline exit condition sooner than would occur for a non-ITIN borrower with otherwise identical financial characteristics.

The three examples presented above collectively demonstrate the primary processing pathways of the manufactured home lending decision engine: first program branch assignment with Counteroffer Type 1 (Example 1), waterfall cascade to the second program branch with Counteroffer Type 2 (Example 2), and ITIN borrower end-to-end processing with sub-prime assignment and the potential for additional counteroffer iterations driven by the elevated fixed interest rate (Example 3). In each case, the system applies manufactured housing specific inputs (including lot rent and dealer invoice based valuation) and iteratively adjusts the down payment until all applicable ratio thresholds are simultaneously satisfied or until the maximum iteration limit is reached.

### Administrative User Interface and Rules Configurability

The decision engine is coupled to an administrative user interface that permits authorized personnel to modify the configurable parameters governing automated underwriting decisions without requiring changes to the underlying application code. Configurable parameter categories include, without limitation: pricing matrices (which map credit score ranges and loan-to-value tiers to interest rates), down payment requirements by program branch and land type, origination fee schedules, mortgage loan originator (MLO) assignment rules, millage rate tables, email notification templates, decline and pend-out reason codes, and partner and community management settings.

Changes made through the administrative user interface are published to the production decision engine within minutes of submission. The system maintains a complete audit trail of all configuration changes, recording the identity of the user who initiated each change, the timestamp, the prior value, and the new value. This audit trail supports regulatory compliance requirements and facilitates rollback in the event that a configuration change produces unintended results.

Access to the administrative user interface is governed by role-based access controls. Different user roles are granted different levels of permission, ranging from read-only access for auditors to full modification privileges for senior underwriting managers. The interface provides preview capabilities that allow an authorized user to review the projected impact of a proposed parameter change before publishing it to the production environment.

Upon completion of the automated underwriting evaluation, the decision engine produces one of four possible outcome classifications: Conditional Approval, Counteroffer, Decline, or Pend Out. A Conditional Approval indicates that the application meets all applicable criteria as submitted. A Counteroffer indicates that the application does not meet all criteria as submitted but can be approved with an adjusted down payment amount. A Decline indicates that the application cannot be approved under any available program branch or counteroffer scenario. A Pend Out indicates that the application requires manual review due to conditions that the automated system cannot resolve.

After the decision is rendered, the system evaluates an email consent verification decision matrix to determine which notification emails to transmit. The matrix considers whether the borrower has provided electronic consent (E-Consent), whether a co-borrower exists and has provided a Credit Inquiry and Report Authorization (CIRA), and the resulting notification actions. The following table describes the consent verification matrix scenarios:

TABLE 4

| | | | | Co-Borrower |
|---|---|---|---|---|
| Scenario | E-Consent | CIRA | Borrower Email | Email |
| Both consent | Yes | Yes | Sent | Sent |
| Borrower only | Yes | No | Sent | Not sent |
| Co-borrower | No | Yes | Not sent | Sent |
| only | | | | |
| Neither | No | No | Not sent | Not sent |
| E-consent | Yes | N/A | Sent | N/A |
| without CIRA | | | | |
| No co-borrower | N/A | N/A | Evaluate borrower | N/A |
| | | | only | |

The consent verification matrix is evaluated by a background Watcher Service after the underwriting decision has been rendered but before any notification emails are transmitted. This sequencing ensures that no notification is sent to a borrower or co-borrower who has not provided the requisite consent authorization.

Notification content is generated from configurable email templates stored in the relational database. Each template corresponds to a specific decision outcome and includes the applicable loan terms, conditions, or reason codes. Templates may be modified through the administrative user interface described herein without requiring changes to application code.

Upon rendering a Conditional Approval or Counteroffer decision, the system automatically assigns a mortgage loan originator (MLO) to the application. The assignment is governed by a configurable rule set that evaluates criteria including the dealer or retailer associated with the application, the geographic state in which the manufactured home is situated, and the partner or community through which the application was originated. The assignment rules are configurable through the administrative user interface and may be modified without requiring code changes.

The systems and methods described herein may be implemented using one or more computing devices. A computing device may be a personal computer, a server computer, a laptop computer, a tablet computer, a smartphone, a personal digital assistant, or any other electronic device capable of executing instructions stored in a computer-readable medium. A computing device may include at least one processor and at least one memory device coupled to the processor and may further include one or more communication interfaces for transmitting and receiving data.

Memory devices suitable for use with the described systems include volatile memory such as random access memory (RAM) and non-volatile memory such as read-only memory (ROM), flash memory, magnetic disk storage, optical disk storage, and other forms of persistent and non-persistent storage. The memory stores instructions that, when executed by the processor, cause the computing device to perform the operations described in this disclosure.

As used herein, the term “software” refers to any set of machine-readable instructions that, when executed by a processor, cause the processor to perform specified operations. Software includes firmware, operating systems, application programs, scripts, and any other form of executable instructions, whether stored locally on a computing device or retrieved from a remote source.

Embodiments of the present disclosure may be provided as a computer program product stored on a non-transitory computer-readable medium. The non-transitory computer-readable medium may be a magnetic disk, an optical disk, a flash memory device, a hard drive, a solid-state drive, or any other tangible storage medium capable of storing instructions that are executable by a processor. The computer program product includes instructions that, when executed by a processor, cause the processor to perform the methods described herein.

In addition to storage on non-transitory computer-readable media, in some embodiments the instructions may be transmitted via a transitory medium such as an electrical signal, an optical signal, an electromagnetic wave, or a carrier wave propagating through a wired or wireless communication channel. Such transitory signals may carry the instructions from a remote server to a local computing device for execution.

The methods and systems described herein may be implemented in whole or in part on general-purpose computers, special-purpose computers, application-specific integrated circuits (ASICs), field-programmable gate arrays (FPGAs), graphics processing units (GPUs), digital signal processors, or any combination thereof. As will be appreciated, the steps of the methods need not all proceed in the order illustrated, and fewer, more, or different steps may be performed.

Although the present disclosure has been described in terms of specific embodiments, it is anticipated that variations and modifications will become apparent to those skilled in the art. It is therefore intended that the following claims be interpreted as covering such variations and modifications within the scope of the appended claims.

What is claimed is:

1. A computer-implemented method for underwriting a manufactured housing chattel loan and generating one or more counteroffers, the method being performed by one or more computing devices comprising at least one processor and memory storing instructions that, when executed by the at least one processor, cause the one or more computing devices to perform operations comprising:
receiving, via an application programming interface, electronic loan application data comprising one or more of a borrower identification number, income data, employment data, property information including a home price and a land type classification, and a stated down payment amount;
performing a plurality of pre-bureau eligibility checks on the electronic loan application data, the pre-bureau eligibility checks comprising one or more of a loan amount threshold check, an occupant borrower status check, and an Individual Taxpayer Identification Number (ITIN) eligibility determination based on the borrower identification number;
transmitting a request to a credit bureau computing system and receiving, in response, a credit report associated with the borrower;
parsing the credit report to extract a credit score and to analyze a plurality of tradeline types comprising one or more of installment tradelines, revolving tradelines, student loan tradelines, mortgage tradelines, home equity line of credit tradelines, collection tradelines, and derogatory tradelines;
assigning the electronic loan application to one of a plurality of program branches in a waterfall cascade, the plurality of program branches comprising a first program branch, a second program branch, and a third program branch, wherein the assigning comprises evaluating the credit score against a threshold for the first program branch and, upon failure to meet the threshold, cascading the evaluation to the second program branch, and upon further failure, cascading to the third program branch;
computing a plurality of financial ratios comprising a housing ratio that includes a lot rent component determined by one or more of the land type classification, a debt-to-income ratio, and a loan-to-value ratio;
determining, based on the stated down payment amount, the plurality of financial ratios, and the assigned program branch, whether to generate a counteroffer;
in response to determining that a counteroffer is to be generated, executing one of two mutually exclusive iterative counteroffer processes, wherein: (a) a first counteroffer process increases the down payment by a predetermined percentage increment when the stated down payment is below a program branch minimum, and recalculates the plurality of financial ratios after each increment until all ratios satisfy applicable thresholds or until an exit condition is met; and (b) a second counteroffer process increases the down payment by a fixed dollar increment when the stated down payment meets the program branch minimum but one or more of the plurality of financial ratios fail within a boundary tolerance range, and recalculates the plurality of financial ratios after each increment until all ratios satisfy applicable thresholds or until a maximum iteration limit is reached; and
transmitting, via the application programming interface, an underwriting decision comprising one of a conditional approval, a counteroffer specifying an adjusted down payment amount, a decline, or a pend out.

2. The method of claim 1, wherein executing the first counteroffer process further comprises: setting the down payment to a program branch minimum percentage of the home price; recalculating the housing ratio, the debt-to-income ratio, and the loan-to-value ratio based on the adjusted down payment; determining whether all recalculated ratios satisfy the applicable thresholds; and upon determining that at least one ratio does not satisfy the applicable threshold, incrementing the down payment by the predetermined percentage increment and repeating the recalculating and determining steps until all ratios satisfy the applicable thresholds or until the exit condition is met, wherein the exit condition comprises the down payment exceeding a maximum percentage of the home price.

3. The method of claim 1, wherein the first counteroffer process is triggered when all of the plurality of financial ratios satisfy their respective thresholds and the stated down payment amount is below the program branch minimum for the assigned program branch.

4. The method of claim 1, wherein executing the second counteroffer process further comprises: incrementing the down payment by a fixed dollar amount; reducing the loan amount by a corresponding fixed dollar amount; recalculating the housing ratio, the debt-to-income ratio, and the loan-to-value ratio based on the adjusted down payment and reduced loan amount; determining whether all recalculated ratios satisfy the applicable thresholds; and upon determining that at least one ratio does not satisfy the applicable threshold, repeating the incrementing, reducing, recalculating, and determining steps until all ratios satisfy the applicable thresholds or until a maximum number of iterations is reached.

5. The method of claim 1, wherein the second counteroffer process is triggered when the stated down payment amount meets or exceeds the program branch minimum and at least one of the plurality of financial ratios fails the applicable threshold but falls within a boundary tolerance range defined by the applicable threshold and a predetermined upper limit.

6. The method of claim 1, wherein the ITIN eligibility determination comprises: detecting that the borrower identification number begins with the digit 9; verifying that the originating partner has opted into a sub-prime program with ITIN lending enabled; assigning a predetermined default credit score to the electronic loan application; routing the electronic loan application to the third program branch regardless of any credit score value; and applying ITIN-specific rules comprising a fixed interest rate that overrides the scoring matrix, an elevated minimum down payment percentage, and an extended employment history verification requirement.

7. The method of claim 1, wherein parsing the credit report to analyze the plurality of tradeline types comprises: for installment tradelines, excluding tradelines below a count threshold and computing monthly obligations from remaining tradelines; for revolving tradelines, imputing a minimum monthly payment when no payment amount is reported; for student loan tradelines, imputing a payment amount based on a percentage of the outstanding balance when the reported payment is zero or deferred; for mortgage and home equity line of credit tradelines, applying inclusion or exclusion rules based on a residence status of the borrower; for collection tradelines, disregarding collections below an age threshold or within an excluded category; and for 401(k) loan tradelines, including the obligation at the stated monthly amount.

8. The method of claim 1, further comprising automatically assigning a mortgage loan originator to the electronic loan application based on a configurable rule set that evaluates at least one of a dealer association, a geographic state, or a partner or community association, wherein the assignment rules are configurable through the administrative user interface without requiring code changes.

9. A system for underwriting a manufactured housing chattel loan and generating one or more counteroffers, the system comprising:
one or more computing devices comprising at least one processor and memory storing instructions;
a relational database coupled to the one or more computing devices and storing loan application data, configurable underwriting parameters, and decision records; and
an administrative user interface coupled to the one or more computing devices and configured to permit modification of the configurable underwriting parameters,
wherein the memory stores instructions that, when executed by the at least one processor, cause the one or more computing devices to:
receive, via an application programming interface, electronic loan application data comprising one or more of a borrower identification number, income data, employment data, property information including a home price and a land type classification, and a stated down payment amount;
perform a plurality of pre-bureau eligibility checks on the electronic loan application data;
retrieve a credit report from a credit bureau computing system and parse the credit report to extract a credit score and analyze a plurality of tradeline types;
assign the electronic loan application to one of a plurality of program branches in a waterfall cascade comprising a first program branch, a second program branch, and a third program branch;
compute a plurality of financial ratios comprising a housing ratio, a debt-to-income ratio, and a loan-to-value ratio;
execute one of two mutually exclusive iterative counteroffer processes, wherein a first counteroffer process adjusts the down payment by a predetermined percentage increment and a second counteroffer process adjusts the down payment by a fixed dollar increment, and wherein only one of the two counteroffer processes is executed for a given loan application; and
transmit, via the application programming interface, an underwriting decision comprising one of a conditional approval, a counteroffer, a decline, or a pend out.

10. The system of claim 9, wherein the mutual exclusivity of the two iterative counteroffer processes is enforced through an evaluation order that determines which process to execute based on the application state at the time of evaluation.

11. The system of claim 10, wherein the evaluation order comprises: first evaluating credit criteria to determine program branch assignment; then computing the plurality of financial ratios; then evaluating whether the stated down payment meets the program branch minimum; and then evaluating whether any failing ratios fall within a boundary tolerance range to determine which, if either, counteroffer process to execute.

12. The system of claim 9, wherein the instructions further cause the computing devices to detect that the borrower identification number begins with the digit 9, identify the borrower as an ITIN applicant, verify partner opt-in for ITIN lending, assign a predetermined default credit score, route the application to the third program branch, and apply ITIN-specific rules comprising a fixed interest rate, an elevated minimum down payment percentage, and an extended employment history verification requirement.

13. The system of claim 9, wherein the instructions further cause the computing devices to analyze the plurality of tradeline types using program-branch-specific rules, the tradeline types comprising one or more of installment, revolving, student loan, mortgage, home equity line of credit, collection, and derogatory tradelines, and further comprising including 401(k) loan obligations at stated monthly amounts.

14. The system of claim 9, wherein the administrative user interface is further configured to permit modification of a pricing matrix that maps credit score ranges and loan-to-value tiers to interest rates, and wherein modifications to the pricing matrix are published to the computing devices within a configurable time interval.

15. The system of claim 9, wherein the housing ratio includes a lot rent component determined according to the land type classification, and wherein the lot rent component is set to a stated lot rent amount when a nonzero lot rent value is present in the electronic loan application data, set to a predetermined default lot rent amount when no lot rent value is stated and the land type classification indicates a community park, and set to zero when the land type classification indicates private land.

16. The system of claim 9, further comprising a background processing service executing on the computing devices on a configurable polling cycle, the background processing service monitoring the relational database for loan applications requiring processing and invoking the underwriting evaluation for each identified application.

17. A non-transitory computer-readable medium storing instructions that, when executed by at least one processor of one or more computing devices, cause the one or more computing devices to perform operations for underwriting a manufactured housing chattel loan and generating one or more counteroffers, the operations comprising:
receiving, via an application programming interface, electronic loan application data comprising one or more of a borrower identification number, income data, employment data, property information including a home price and a land type classification, and a stated down payment amount;
performing a plurality of pre-bureau eligibility checks on the electronic loan application data, including an Individual Taxpayer Identification Number eligibility determination;
retrieving a credit report from a credit bureau computing system and parsing the credit report to extract a credit score and analyze a plurality of tradeline types;
assigning the electronic loan application to one of a plurality of program branches via a waterfall cascade;
computing a plurality of financial ratios comprising a housing ratio that includes a lot rent component determined by the land type classification, a debt-to-income ratio, and a loan-to-value ratio;
executing one of two mutually exclusive iterative counteroffer processes to adjust the stated down payment amount, wherein a first counteroffer process adjusts the down payment by a predetermined percentage increment and a second counteroffer process adjusts the down payment by a fixed dollar increment; and
transmitting, via the application programming interface, an underwriting decision comprising one of a conditional approval, a counteroffer specifying an adjusted down payment amount, a decline, or a pend out.

18. The non-transitory computer-readable medium of claim 17, wherein the method further comprises detecting that the borrower identification number begins with the digit 9, identifying the borrower as an ITIN applicant, verifying partner opt-in for ITIN lending, assigning a predetermined default credit score, routing the application to a sub-prime program branch, and applying ITIN-specific rules comprising a fixed interest rate, an elevated minimum down payment percentage, and an extended employment history verification requirement.

19. The non-transitory computer-readable medium of claim 17, wherein the two mutually exclusive iterative counteroffer processes are configured such that only one of the first counteroffer process and the second counteroffer process is executed for any given loan application, the first counteroffer process being triggered when all financial ratios satisfy applicable thresholds and the stated down payment is below a program branch minimum, and the second counteroffer process being triggered when the stated down payment meets or exceeds the program branch minimum and at least one financial ratio fails but falls within a boundary tolerance range.

20. The non-transitory computer-readable medium of claim 17, wherein the lot rent component of the housing ratio is determined by the land type classification such that: when the land type classification indicates a community park and a nonzero lot rent value is stated in the electronic loan application data, the lot rent component is set to the stated value; when the land type classification indicates a community park and no lot rent value is stated, the lot rent component is set to a predetermined default value; and when the land type classification indicates private land, the lot rent component is set to zero.
